(19) United States
(12) Patent Application Publication
(10) Pub. No.: US 2024/0196126 A1
(43) Pub. Date: Jun. 13, 2024

(54) CRADLE, AND WIRELESS AUDIO SYSTEM INCLUDING THE SAME

(71) Applicant: LG ELECTRONICS INC., Seoul (KR)

(72) Inventors: Junwoo CHOI, Seoul (KR); Kiyoung LEE, Seoul (KR); Jaeyoung PARK, Seoul (KR); Junyoung PARK, Seoul (KR); Yunjin CHOI, Seoul (KR)

(73) Assignee: LG ELECTRONICS INC., Seoul (KR)

(21) Appl. No.: 18/227,695

(22) Filed: Jul. 28, 2023

(30) Foreign Application Priority Data
Dec. 7, 2022 (KR) 10-2022-0169805

(51) Int. Cl. H04R 1/10; H02J 7/00

(52) U.S. Cl. CPC H04R 1/1041; H02J 7/0044; H04R 1/1025; H04R 2420/05; H04R 2420/07; H04R 2460/17

(57) ABSTRACT

Discussed is a cradle for a wireless audio device. The cradle can include a casing including a seating groove for seating the wireless audio device, wherein the casing is able to be opened and closed, a transceiver disposed in the casing, a switch formed in a part of the casing, and an external device interface including an input terminal formed in another part of the casing, wherein in response to a first cable being connected to the input terminal in a wired connection mode, one of the transceiver and the external device interface performs a bi-directional wireless audio transmission for audio signal exchange with the wireless audio device, and wherein in response to a second cable being connected to the input terminal in the wired connection mode, one of the transceiver and the external device interface performs a unidirectional wireless audio transmission for audio transmission to the wireless audio device.

### CROSS-REFERENCE TO RELATED APPLICATION

This application claims priority to Korean Patent Application No. 10-2022-0169805 filed in the Republic of Korea on Dec. 7, 2022, the entire contents of which are hereby expressly incorporated by reference into the present application.

### BACKGROUND

### Field

This disclosure relates to a cradle and a wireless audio system including the same, and more particularly, to a cradle capable of performing a bidirectional or unidirectional wireless audio transmission through a wired connection mode, and a wireless audio output including the same.

### Discussion of the Related Art

A wireless audio device wirelessly receives an audio signal from an external wireless audio transmission device, converts the received audio signal into sound, and outputs the converted sound.

For example, if the wireless audio device is portable, when it is mounted inside a cradle, charged, and then pulled out of the cradle, the wireless audio device wirelessly receives an audio signal through a wireless connection with a wireless audio transmission device, and converts the received audio signal into sound and outputs the converted sound.

Meanwhile, Korean Patent Registration No. 10-2214661 (hereinafter, referred to as a prior document) relates to a sound system using a wireless earbud and a charging cradle, and discloses that sound emitted from a wireless earbud is emitted through an echo space of a horn structure formed in a charging cradle.

Meanwhile, according to the prior document, as the distance between the wireless earbud, which is a wireless audio device, and the wireless audio transmission device increases, the strength of the wireless signal decreases, so that stable wireless audio transmission is restricted.

Accordingly, a method for securing a stable wireless connection distance between a wireless audio transmission device and a wireless audio device has been researched.

### SUMMARY OF THE DISCLOSURE

The disclosure has been made in view of the above problems, and can provide a cradle capable of performing a bidirectional or unidirectional wireless audio transmission through a wired connection mode, and a wireless audio system having the same.

The disclosure can further provide a cradle capable of performing a bi-directional or unidirectional wireless audio transmission according to the type of connected cable in a wired connection mode, and a wireless audio system including the same.

The disclosure can further provide a cradle capable of supporting a wireless conversation mode in a wired connection mode, and a wireless audio system including the same.

The disclosure can further provide a cradle capable of stably performing wireless audio transmission even in a complicated wireless environment, and a wireless audio system having the same.

The disclosure can further provide a cradle capable of seamlessly switching an audio service through a first communication module and a second communication module of different communication standards, and a wireless audio system including the same.

In accordance with an aspect of the present disclosure, a cradle and a wireless audio system having the same include: a casing including a seating groove for seating a wireless audio device, wherein the casing is at least partially opened and closed; a transceiver disposed in the casing; a switch formed in a part of the casing; and an interface including an input terminal formed in another part of the casing, wherein in response to a first cable being connected to the input terminal in a wired connection mode, the transceiver performs bi-directional wireless audio transmission for audio signal exchange with the wireless audio device, and wherein in response to a second cable being connected to the input terminal in the wired connection mode, the transceiver performs unidirectional wireless audio transmission for audio transmission to the wireless audio device.

Meanwhile, in response to the first cable being connected to the input terminal in the wired connection mode, the interface performs bi-directional wired audio transmission for exchanging audio signals with an electronic device connected to the input terminal by wire, and in response to a second cable being connected to the input terminal in the wired connection mode, performs unidirectional wired audio reception for receiving an audio signal from an electronic device connected to the input terminal by wire.

Meanwhile, in response to a first mode being set through the switch, the wired connection mode is activated, and in response to a second mode being set through the switch, the wired connection mode is deactivated.

Meanwhile, in response to the first mode being switched to the second mode, the interface stops an audio signal exchange with an electronic device connected to the input terminal by wire, or stops an audio signal reception.

Meanwhile, in response to the first cable being connected to the input terminal in the wired connection mode, the transceiver wirelessly receives a first audio signal from the wireless audio device, and the interface converts the first audio signal received from the transceiver and transmits the converted first audio signal to an electronic device connected to the input terminal by wire, and wherein the interface receives a second audio signal from the electronic device, and the transceiver converts the second audio signal and wirelessly transmits the converted second audio signal to the wireless audio device.

Meanwhile, in response to the second cable being connected to the input terminal in the wired connection mode, the interface receives a third audio signal from the electronic device, wherein the transceiver converts the third audio signal and wirelessly transmits the converted third audio signal to the wireless audio device.

Meanwhile, in response to the second cable being connected to the input terminal in the wired connection mode, the transceiver wirelessly receives a fourth audio signal from the wireless audio device, wherein the interface does not transmit a converted fourth audio signal to an electronic device connected to the input terminal by wire.

Meanwhile, in response to the second cable being connected to the input terminal in the wired connection mode, the transceiver does not wirelessly receive an audio signal from the wireless audio device.

Meanwhile, in response to a connection of the first cable connected to the input terminal being disconnected in the wired connection mode, the transceiver attempts a wireless connection with the electronic device connected to the input terminal by wire.

Meanwhile, in response to a connection of the second cable connected to the input terminal being disconnected in the wired connection mode, the transceiver attempts a wireless connection with the electronic device connected to the input terminal by wire.

Meanwhile, the transceiver includes: a first communication module configured to wirelessly exchange audio or transmits audio with or to the wireless audio device based on a first communication standard of a first frequency band; and a second communication module configured to wirelessly exchange audio or transmits audio with or to the wireless audio device based on a second communication standard of a second frequency band greater than the first frequency band, and any one of the first communication module and the second communication module performs audio exchange or audio transmission with or to the wireless audio device.

Meanwhile, the transceiver performs audio exchange or audio transmission with or to the wireless audio device during a first period through the first communication module, and in response to a packet error rate of the exchanged or transmitted audio signal being greater than or equal to a certain value during the first period, performs audio exchange or audio transmission with or to the wireless audio device through the second communication module, during a second period after the first period.

Meanwhile, the first communication module transmits a message for switching to the second communication standard to the wireless audio device, in response to the packet error rate of the audio signal exchanged in or transmitted from the first communication module being greater than or equal to the certain value.

In accordance with another aspect of the present disclosure, a cradle and a wireless audio system having the same include: a casing including a seating groove for seating a wireless audio device, wherein the casing is at least partially opened and closed; a transceiver disposed in the casing; a switch formed in a part of the casing; and an interface including an input terminal formed in another part of the casing, wherein in response to a first mode being set through the switch, a wired connection mode with an electronic device connected to the input terminal is activated, and a wireless connection mode with the wireless audio device is activated, and in response to a second mode being set through the switch, the wired connection mode is deactivated and the wireless connection mode with the wireless audio device is activated.

Meanwhile, in response to the first cable being connected to the input terminal in the wired connection mode, the transceiver performs bi-directional wireless audio transmission for audio signal exchange with the wireless audio device, and wherein in response to a second cable being connected to the input terminal in the wired connection mode, the transceiver performs unidirectional wireless audio transmission for audio transmission to the wireless audio device.

In accordance with another aspect of the present disclosure, a wireless audio system includes a wireless audio device, and a cradle.

### BRIEF DESCRIPTION OF THE DRAWINGS

The above and other objects, features and advantages of the present disclosure will be more apparent from the following detailed description in conjunction with the accompanying drawings, in which:

FIG. 1 is a diagram illustrating a wireless audio system according to an embodiment of the present disclosure;

FIG. 2 is a diagram illustrating a case in which a casing of a cradle of FIG. 1 is closed;

FIG. 3 is a diagram showing a rear of the cradle of FIG. 1;

FIG. 4 is a diagram illustrating an outer shape of a wireless audio device of FIG. 1;

FIGS. 5A to 5C are diagrams illustrating connections of various cables to a cradle according to an embodiment of the present disclosure;

FIGS. 6A to 6B are diagrams illustrating various examples of an electronic device capable of wired connection to a cradle according to an embodiment of the present disclosure;

FIG. 7A is an example of an internal block diagram of a cradle according to an embodiment of the present disclosure;

FIG. 7B is an example of an internal block diagram of a wireless audio device based on an embodiment of the present disclosure;

FIG. 8 is a flowchart illustrating an operation of a cradle according to an embodiment of the present disclosure; and

FIGS. 9A to 12C are diagrams for explaining FIG. 9.

### DETAILED DESCRIPTION OF THE EMBODIMENTS

Hereinafter, the present disclosure will be described in more detail with reference to the drawings.

The suffixes such as “module” and “unit” can be used to refer to elements or components. Use of such suffixes herein is merely intended to facilitate description of the specification, and the suffixes do not have any special meaning or function. Accordingly, the “module” and “unit” can be used interchangeably.

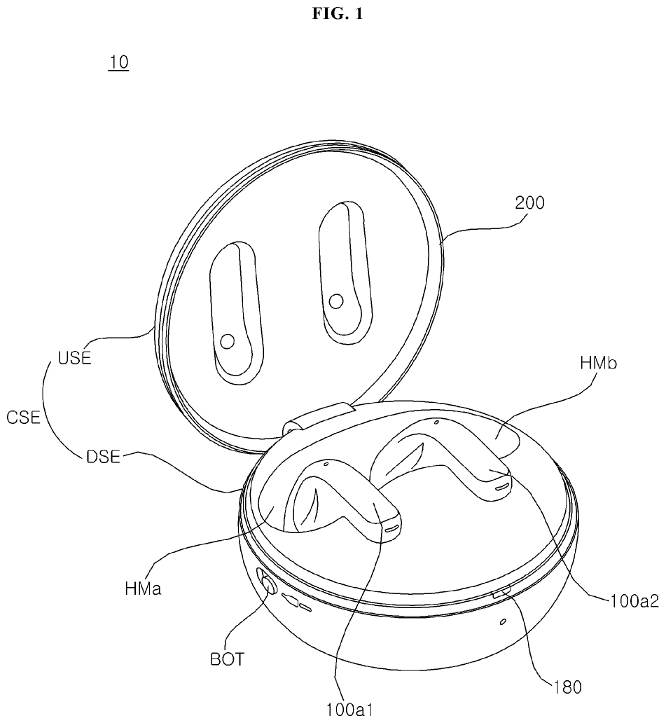

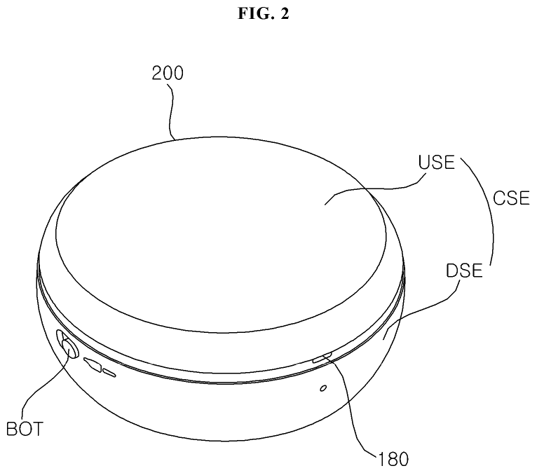

FIG. 1 is a diagram illustrating a wireless audio system according to an embodiment of the present disclosure, and FIG. 2 is a diagram illustrating a case in which a casing of a cradle of FIG. 1 is closed.

Referring to the drawings, a wireless audio system 10 according to an embodiment of the present disclosure includes a wireless audio device 100al, 100a2 and a cradle 200.

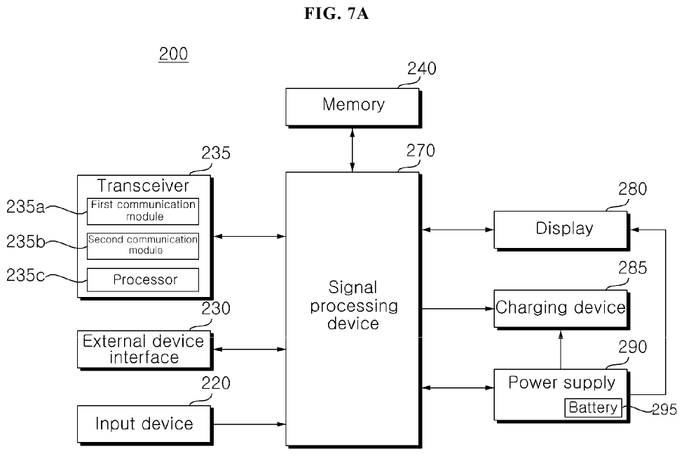

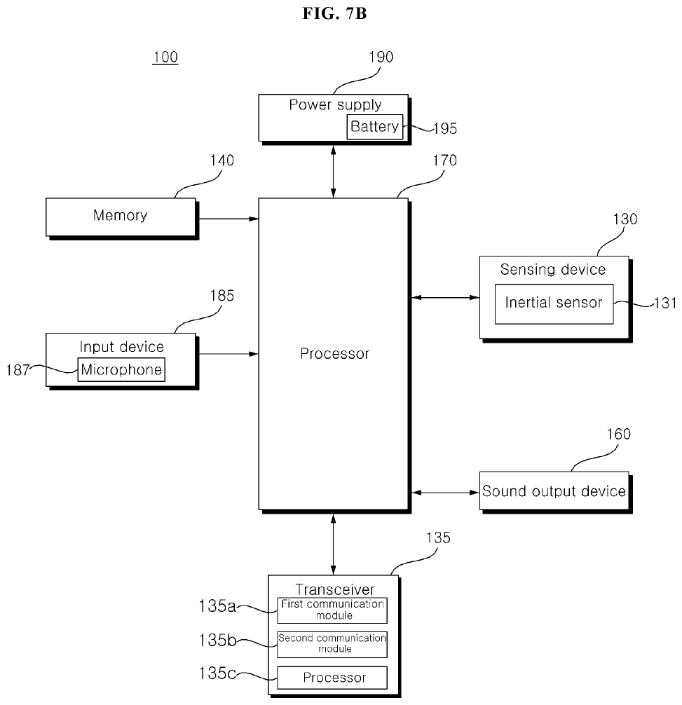

The cradle 200 according to an embodiment of the present disclosure includes a casing CSE in which at least a part is opened and closed, a transceiver (235 in FIG. 7A) disposed in the casing CSE, a switch BOT formed in a part of the casing CSE, and an interface (230 in FIG. 7A) including an input terminal TE formed in another part of the casing CSE.

The casing CSE has a seating groove HMa, HMb for seating the wireless audio device 100a1, 100a2, and at least a part thereof is opened and closed.

For example, the casing CSE includes an upper casing USE and a lower casing DSE, and the upper casing USE can be opened and closed.

Meanwhile, the seating groove HMa, HMb can be formed in the lower casing DSE, and a display 180 for displaying an operating state can be disposed in a part of the lower casing DSE.

Meanwhile, a switch BOT for setting a first mode, which is a wired connection mode, or a second mode, which is a wireless connection mode, can be disposed in a side surface of the lower casing DSE.

When the wireless audio device 100al, 100a2 is seated in the seating groove HMa, HMb, the wireless audio device 100a1, 100a2 can be charged through a charging terminal respectively.

Meanwhile, when the wireless audio device 100a1, 100a2 is separated from the seating groove HMa, HMb, they are separated from the charging terminal, so that a transceiver 135 in the wireless audio device 100a1, 100a2 is activated, and an attempt for wireless communication with a nearby electronic device (600 or 600b) or the cradle 200 can be performed.

For example, when the wireless audio device 100a1, 100a2 is separated from the seating groove HMa, HMb, the transceiver 235 in the cradle 200 can transmit a pairing request signal based on a first communication standard to the wireless audio device 100a1, 100a2, and receive a pairing response signal of the first communication standard from the wireless audio device 100a1, 100a2.

As another example, when the wireless audio device 100al, 100a2 are separated from the seating groove HMa, HMb, the transceiver 235 in the cradle 200 can transmit a pairing request signal based on a second communication standard to the wireless audio device 100al, 100a2, and receive a pairing response signal of the second communication standard from the wireless audio device 100a1, 100a2.

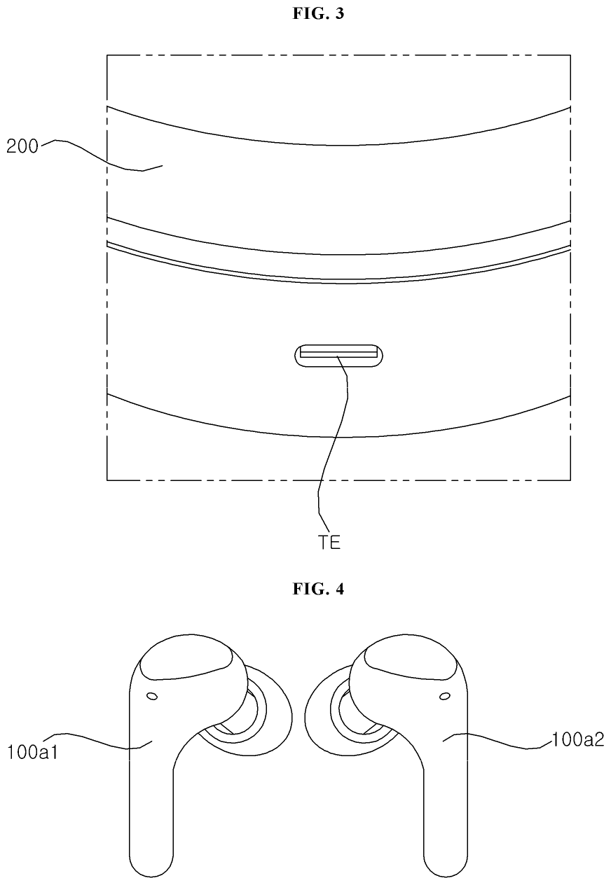

FIG. 3 is a diagram showing a rear of the cradle of FIG. 1.

Referring to FIG. 3, an input terminal TE for cable connection is formed in the rear of the cradle 200, particularly, in the rear of the lower casing DSE.

For example, the cradle 200 includes an interface (230 in FIG. 7A) including an input terminal TE formed in another part of the casing CSE.

Meanwhile, the input terminal TE can be a USB-c type terminal, but is not limited thereto, and can be formed of terminals of various standards.

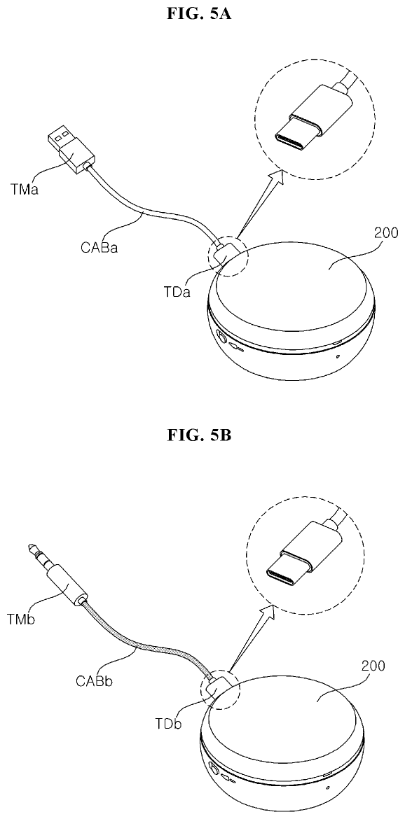

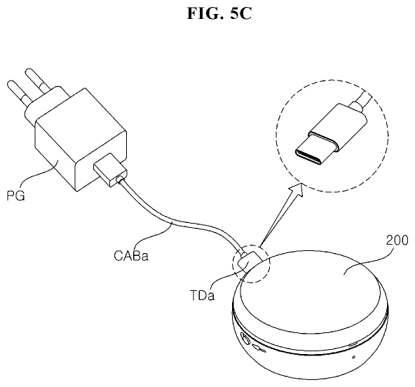

Meanwhile, a first cable (CABa in FIG. 5A), which is a digital cable, or a second cable (CABb in FIG. 5B), which is an analog cable, can be connected to the input terminal TE.

FIG. 4 is a diagram illustrating an outer shape of the wireless audio device of FIG. 1.

Referring to FIG. 4, when the wireless audio device 100al, 100a2 is separated from the seating groove HMa, HMb in the casing CSE, the transceiver 135 can be activated.

Accordingly, the wireless audio device 100a1, 100a2 can perform wireless communication with the nearby electronic device (600 or 600b) or the cradle 200.

FIG. 5A to 5C are diagrams illustrating connection of various cables to a cradle according to an embodiment of the present disclosure.

FIG. 5A illustrates connecting a first cable CABa to the cradle 200.

Referring to FIG. 5, one end TDa of the first cable CABa can be connected to the input terminal TE of the cradle 200.

Meanwhile, the other end TMa of the first cable CABa can be connected to the input terminal of the electronic device (600 or 600b).

Meanwhile, the other end TMa of the first cable CABa can be a USB A type terminal, but is not limited thereto and various modifications are possible.

FIG. 5B is a diagram showing the connection of a second cable CABb to the cradle 200.

Referring to FIG. 5B, one end TDb of the second cable CABb can be connected to the input terminal TE of the cradle 200.

Meanwhile, the other end TMb of the second cable CABb can be connected to the input terminal of the electronic device (600 or 600b).

Meanwhile, the other end TMb of the second cable CABb can be an Aux terminal, but is not limited thereto and various modifications are possible.

FIG. 5C illustrates that the first cable CABa is connected to the cradle 200 and a power conversion plug PG is connected to the other end TMa of the first cable CABa.

Referring to FIG. 5C, when the first cable CABa is connected to the cradle 200, and when the power conversion plug PG is connected to the other end TMa of the first cable CABa, a DC voltage is charged to a battery (295 in FIG. 7A) inside the cradle device 200.

The first cable CABa can be a cable for bidirectional data transmission and a cable for DC voltage transmission.

Meanwhile, unlike FIG. 5C, a third cable other than the first cable CABa can be connected to the power conversion plug PG.

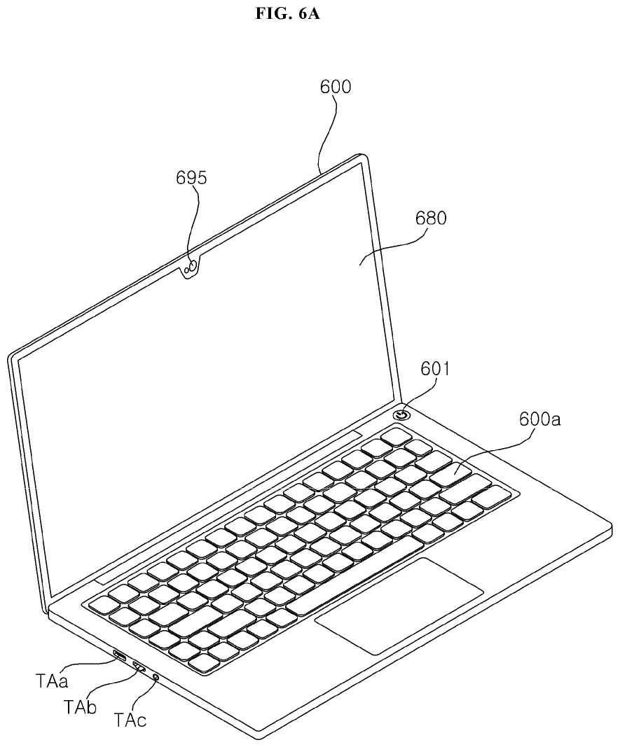

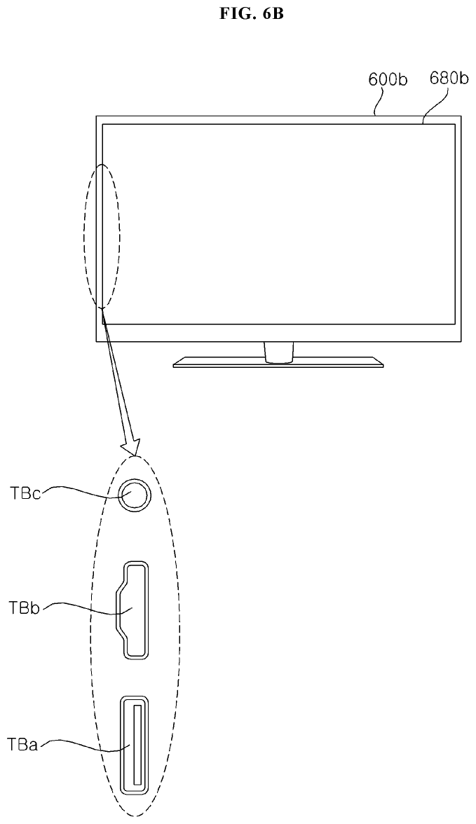

FIGS. 6A to 6B are diagrams illustrating various examples of electronic devices capable of wired connection to a cradle according to an embodiment of the present disclosure.

First, FIG. 6A illustrates a notebook computer 600 as an example of an electronic device.

Referring to FIG. 6A, the notebook computer 600, which is an example of an electronic device, can include a display 680, a character key 600a, a power key 601, a camera 695, and a plurality of input terminals TAa, TAb, and TAc.

Among the plurality of input terminals TAa, TAb, and TAc, a first input terminal TAa can be a USB-A type terminal, a second input terminal TAb can be an HDMI terminal, and a third input terminal TAc can be an AUX terminal.

For example, the first cable CABa of FIG. 5A can be connected to the first input terminal TAa, or the second cable CABa of FIG. 5B can be connected to the third input terminal TAc.

Next, FIG. 6B illustrates an image display device 600b as an example of an electronic device.

The image display device 600b can be a TV, a monitor, a tablet PC, or a vehicle display device.

Referring to FIG. 6B, the image display device 600b, which is an example of an electronic device, can include a display 680b and a plurality of input terminals TBa, TBb, and TBc.

Among the plurality of input terminals TBa, TBb, and TBc, the first input terminal TBa can be a USB-A type terminal, the second input terminal TBb can be an HDMI terminal, and the third input terminal TBc can be an AUX terminal.

For example, the first cable CABa of FIG. 5A can be connected to the first input terminal TBa, or the second cable CABa of FIG. 5B can be connected to the third input terminal TBc.

FIG. 7A is an example of an internal block diagram of a cradle according to an embodiment of the present disclosure.

Referring to FIG. 7A, the cradle 200 can include an input device 220, an external device interface 230, a transceiver 235, a memory 240, a signal processing device 270, a display 280, a charging device 285, and a power supply 290. When these components are implemented in actual applications, two or more components can be combined into one component, or one component can be subdivided into two or more components as needed.

The input device 220 can include a switch BOT for setting a first mode which is a wired connection mode, or a second mode which is a wireless connection mode.

The switch BOT is formed in the side surface of the casing CSE, and can be an analog switch.

The external device interface 230 includes an input terminal TE formed in another part of the casing CSE.

Meanwhile, when the first cable CABa or the second cable CABb is connected to the input terminal TE, the interface 230 can detect a cable type through a detect pin and, accordingly, can vary an internal setting value.

In the wired connection mode, when the first cable CABa is connected to the input terminal TE, the external device interface 230 can perform bi-directional wired audio transmission for exchanging audio signals with the electronic device (600 or 600b) connected to the input terminal TE by wire.

In the wired connection mode, when the second cable CABb is connected to the input terminal TE, the external device interface 230 can perform unidirectional wired audio reception for audio signal reception from the electronic device (600 or 600b) connected to the input terminal TE by wire.

Meanwhile, the external device interface 230 can activate the wired connection mode in response to a first mode being set through the switch BOT, and deactivate the wired connection mode in response to a second mode being set through the switch BOT.

Meanwhile, in response to the first mode being converted to the second mode, the external device interface 230 can stop an audio signal exchange with the electronic device (600 or 600b) connected to the input terminal TE by wire or can stop an audio signal reception.

Meanwhile, the transceiver 235 can provide an interface for communication with the wireless audio device 100a1, 100a2 or an external electronic device (600 or 600b).

For example, the transceiver 235 can exchange data with or transmit data to a paired wireless audio device 100a1, 100a2.

As another example, the transceiver 235 can exchange data with or transmit data to a paired external electronic device (600 or 600b).

Meanwhile, when the first cable CABa or the second cable CABb is connected to the input terminal TE, the transceiver 235 can detect the type of cable through a detect pin, and accordingly, can vary the internal setting value.

Meanwhile, in the wired connection mode, when the first cable CABa is connected to the input terminal TE, the transceiver 235 can performs bi-directional wireless audio transmission for audio signal exchange with the wireless audio device 100a1, 100a2.

Meanwhile, when the second cable CABb is connected to the input terminal TE in the wired connection mode, the transceiver 235 performs unidirectional wireless audio transmission for audio transmission to the wireless audio device 100a1, 100a2.

Meanwhile, when the first cable CABa is connected to the input terminal TE in the wired connection mode, the transceiver 235 can perform settings for an Advanced Audio Distribution Profile (A2DP) and a Hands Free Profile (HFP), for bi-directional wireless audio transmission with the wireless audio device 100a1, 100a2.

Specifically, when the first cable CABa is connected to the input terminal TE in the wired connection mode, the transceiver 235 can activate an Advanced Audio Distribution Profile (A2DP) protocol, and make a call profile (HFP) protocol to be ready.

Meanwhile, in the transceiver 235, in the wired connection mode, when the second cable CABb is connected to the input terminal TE, only the Advanced Audio Distribution Profile (A2DP) profile can be set, and the setting for the call profile (HFP) need not be performed.

Specifically, the transceiver 235 can activate only the Advanced Audio Distribution Profile (A2DP) protocol, when the second cable CABb is connected to the input terminal TE in the wired connection mode.

Meanwhile, the transceiver 235 can include a first communication module 235a that wirelessly receives a first audio signal according to a first communication standard of a first frequency band, and a second communication module 235b that wirelessly receives a second audio signal according to a second communication standard of a second frequency band greater than the first frequency band.

Meanwhile, audio exchange or audio transmission with the wireless audio device 100a1, 100a2 can be performed by using either the first communication module 235a or the second communication module 235b.

Meanwhile, the transceiver 235 can further include a processor 235c for signal processing or control of the first communication module 235a and the second communication module 235b.

Meanwhile, the first communication module 235a transmits a first signal data through a first channel, and separately transmits a first audio data through a second channel, and the second communication module 235b separately transmits a second signal data and a second audio data through the same channel.

Meanwhile, a beacon message transmitted from the second communication module 235b can include unicast information or broadcast information. Accordingly, it can be operated by separating into unicast and broadcast.

Meanwhile, when unicast information is included in the transmitted beacon message, the second communication module 235b can transmit association request information to the wireless audio device 100al, 100a2, and can receive association response information from the wireless audio device 100al, 100a2. Accordingly, it can be operated by separating into unicast and broadcast.

Meanwhile, the second communication module 235b can distinguish whether it is the second signal data or the second audio data, based on identification information in a header among the transmitted second audio signal. Accordingly, signal data and audio data can be separated, thereby stably transmitting audio wirelessly.

Meanwhile, the second communication module 235b can distinguish whether it is the second signal data or the second audio data, based on identification information in a media access control (MAC) header or a physical (PHY) header among transmitted second audio signal. Accordingly, signal data and audio data can be separated, thereby stably transmitting audio wirelessly.

Meanwhile, when the second signal data is transmitted, the second communication module 235b can extract encoding or decoding information of the second standard, and based on the extracted encoding or decoding information, transmit second audio data after the second signal data, and can set a replay time of the second audio data. Accordingly, signal data and audio data can be separated, thereby stably transmitting audio wirelessly.

Meanwhile, the transceiver 235 can perform audio exchange or audio transmission with the wireless audio device 100a1, 100a2 during a first period through the first communication module 235a, and when a packet error rate of the exchanged or transmitted audio signal is greater than or equal to a certain value, during the first period, can perform audio exchange or audio transmission with the wireless audio device 100a1, 100a2 through the second communication module 235b, during a second period after the first period. Accordingly, audio service switching can be performed seamlessly through the first communication module 235a and the second communication module 235b of different communication standards.

Meanwhile, when the packet error rate of the audio signal exchanged or transmitted in the first communication module 235a is greater than or equal to a certain value, the first communication module 235a can transmit a message of switching to the second communication standard to the wireless audio device 100al, 100a2. Accordingly, audio service switching can be performed seamlessly through the first communication module 235a and the second communication module 235b of different communication standards.

The memory 240 can store a program for processing or controlling the signal processing device 270 in the cradle 200, or can perform a function for temporarily storing input or output data.

Meanwhile, the signal processing device 270 can perform signal processing on an audio signal received from the outside.

Meanwhile, the signal processing device 270 can perform signal processing on an audio signal received through wired communication through the external device interface 230, and transmit the signal-processed audio signal to the transceiver 235. The display 280 can display an operating state of the cradle. To this end, the display 280 can include an LED or the like.

The charging device 285 can charge the wireless audio device 100al, 100a2 seated in the seating groove HMa, HMb in the casing CSE, by using a DC voltage input through the input terminal TE in the external device interface 230.

The charging device 285 can charge the wireless audio device 100al, 100a2 seated in the seating groove HMa, HMb in the casing CSE, by using DC voltage from the battery 295.

The power supply 290 can supply power required for operation of each component.

In particular, the power supply 290 can include the battery 295 that stores and outputs DC power.

FIG. 7B is an example of an internal block diagram of a wireless audio device based on an embodiment of the present disclosure.

Referring to FIG. 7B, an audio device 100 composed of the wireless audio device 100a1, 100a2 can include a sensing device 130, a transceiver 135, a memory 140, a sound output device 160, a processor 170, an input device 185, and a power supply 190. When these components are implemented in actual applications, two or more components can be combined into one component, or one component can be subdivided into two or more components as needed.

The sensing device 130 can include an inertial sensor 131. The inertial sensor can include an acceleration sensor, a gyro sensor, a gravity sensor, or the like. For example, the acceleration sensor, the gyro sensor, the gravity sensor, or the like can include a 6-axis sensor.

The sensing device 130 can output motion information of the wireless audio device 100a1, 100a2, for example, movement information (acceleration information, angular velocity information) or location information based on x, y, z axis.

Meanwhile, the sensing device 130 can include a sensor for obtaining user body information. For example, a blood pressure sensor, a brain wave sensor, or the like can be provided.

Meanwhile, the transceiver 135 can provide an interface for communication with an external device. To this end, the transceiver 135 can include at least one of a mobile communication module, a wireless Internet module, a short-distance communication module, or a GPS module.

For example, the transceiver 135 can perform IR communication, Bluetooth communication, or WiFi communication, thereby exchanging data with or transmitting data to the paired electronic device (600 or 600b) or the cradle 200. In particular, it can receive an audio signal from the paired electronic device (600 or 600b) or the cradle 200.

Meanwhile, the transceiver 135 can include a first communication module 135a that wirelessly receives a first audio signal according to a first communication standard of a first frequency band, and a second communication module 135b that wirelessly receives a second audio signal according to a second communication standard of a second frequency band greater than the first frequency band.

Meanwhile, the transceiver 135 can further include a processor 135c for signal processing or control of the first communication module 135a and the second communication module 135b.

Meanwhile, the first communication module 135a receives a first signal data through a first channel CH1, and separately receives a first audio data through a second channel CH2, and the second communication module 135b separately receives a second signal data and a second audio data through the same channel CHm.

Accordingly, a bidirectional or unidirectional wireless audio transmission can be performed according to the type of connected cable in the wired connection mode. In addition, signal data and audio data can be distinguished in the first communication module 135a and the second communication module 135b, so that audio can be stably received wirelessly and sound can be output.

Meanwhile, the beacon message received by the second communication module 135b can include unicast information or broadcast information. Accordingly, it can be operated by dividing into unicast and broadcast.

Meanwhile, when unicast information is included in the received beacon message, the second communication module 135b can transmit association request information to the electronic device (600 or 600b) or the cradle 200, and receive association response information from the device (600 or 600b) or the cradle 200. Accordingly, it can be operated by dividing into unicast and broadcast.

Meanwhile, the second communication module 135b can distinguish whether it is the second signal data or the second audio data, based on identification information in the header among the received second audio signal. Accordingly, signal data and audio data can be distinguished, thereby stably receiving audio wirelessly and outputting sound.

Meanwhile, the second communication module 135b can distinguish whether it is the second signal data or the second audio data, based on identification information in a media access control (MAC) header or a physical (PHY) header among the received second audio signal. Accordingly, signal data and audio data can be distinguished, thereby stably receiving audio wirelessly and outputting sound.

Meanwhile, when receiving the second signal data, the second communication module 135b can extract encoding or decoding information of the second standard, and based on the extracted encoding or decoding information, can receive the second audio data after the second signal data, and can set a replay time of the second audio data. Accordingly, signal data and audio data can be distinguished, thereby stably receiving audio wirelessly and outputting sound.

The memory 140 can store programs for processing or controlling the processor 170 in the wireless audio device 100al, 100a2, or can perform a function for temporarily storing input or output data.

The sound output device 160 can output an audio signal processed by the processor 170 in the wireless audio device 100a1, 100a2.

Alternatively, the sound output device 160 can output guide information related to the operation of the wireless audio device 100al, 100a2 as an audio signal.

Meanwhile, the sound output device 160 can output a first sound corresponding to the first audio signal from the first communication module 135a or a second sound corresponding to the second audio signal from the second communication module 135b.

The processor 170 can control the overall operation of the wireless audio device 100al, 100a2 by controlling the operation of each unit in the wireless audio device 100a1, 100a2.

Meanwhile, the processor 170 can perform signal processing for an audio signal received from the outside.

Meanwhile, the processor 170 can replay an audio signal from the first communication module 135a or the second communication module 135b.

Meanwhile, the processor 170 can replay the second audio data, based on the decoding information from the second communication module 135b and a set replay time. Accordingly, signal data and audio data can be distinguished, thereby stably receiving audio wirelessly and outputting sound.

Meanwhile, the input device 185 can include a button for initializing the wireless audio device 100a1, 100a2, or inputting an operation.

Meanwhile, the input device 185 can include a microphone 187 for sound collection.

The power supply 190 can supply power required for operation of each component under the control of the processor 170.

In particular, the power supply 190 can include a battery 195 that stores and outputs DC power.

Meanwhile, each of the wireless audio device 100a1, 100a2 wirelessly outputs a first sound, based on the first audio signal according to the first communication standard of the first frequency band received from the first communication module 135a. However, when the wireless environment is complicated and the packet error rate of the first audio signal is greater than or equal to a certain value, the wireless audio device 100a1, 100a2 can output a second sound wirelessly, based on the second audio signal, according to the second communication standard of the second frequency band received by the second communication module 135b. Accordingly, even when the wireless environment is complicated, it is possible to stably receive audio wirelessly and output sound.

Meanwhile, each of the wireless audio device 100a1, 100a2 can output the first sound based on the first audio signal according to the first communication standard, and then, for a certain period of time, before outputting the second sound based on the second audio signal according to the second communication standard, each of the first communication module 135a and the second communication module 135b simultaneously receive an audio signal, and can output sound, based on any one audio signal. Accordingly, seamless audio service switching is possible.

At this time, the plurality of wireless audio devices 100al and 100a2 can be left and right wireless audio devices, respectively.

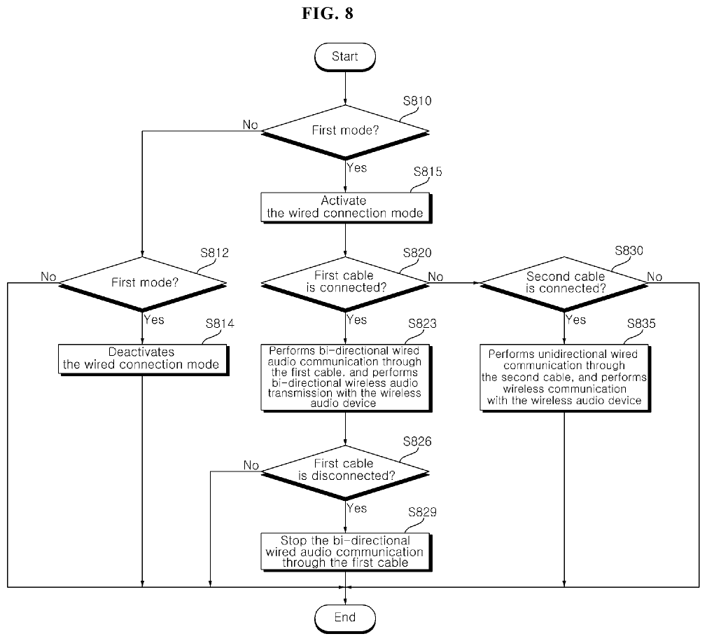

FIG. 8 is a flowchart illustrating an operation of a cradle according to an embodiment of the present disclosure.

Referring to FIG. 8, the cradle 200 according to the embodiment of the present disclosure can activate the wired connection mode (S815), in response to the first mode being set by the switch BOT (S810).

The external device interface 230 in the cradle 200 can activate the wired connection mode, in response to the first mode being set by the switch BOT (S810).

Next, the external device interface 230 in the cradle 200 detects whether the first cable CABa is connected to the input terminal TE (S820), and if applicable, performs bi-directional wired audio communication with the connected electronic device (600 or 600b) through the first cable CABa, and the transceiver 235 in the cradle 200 performs bi-directional wireless audio transmission with the wireless audio device 100a1, 100a2 (S823).

For example, in the wired connection mode, when the first cable CABa is connected to the input terminal TE, the transceiver 235 wirelessly receives the first audio signal Sga from the wireless audio device 100al, 100a2, the interface 230 converts the first audio signal Sga received from the transceiver 235, and transmits the converted first audio signal Sga to an electronic device (600 or 600b) wire-connected to the input terminal TE. In addition, the interface 230 receives the second audio signal Sgb from the electronic device (600 or 600b), and the transceiver 235 can convert the second audio signal Sgb and wirelessly transmit the converted second audio signal Sgb to the wireless audio output device 100al and 100a2.

Meanwhile, after step 823 (S823), the external device interface 230 in the cradle 200 detects whether the connection of the first cable CABa connected to the input terminal TE is disconnected in the wired connection mode (S826), and if applicable, the bi-directional wired audio communication with the electronic device (600 or 600b) through the first cable CABa can be stopped (S829).

Meanwhile, in the wired connection mode, when the connection of the first cable CABa connected to the input terminal TE is disconnected, the transceiver 235 can attempt a wireless connection with the electronic device (600 or 600b) connected to the input terminal TE by wire. Accordingly, seamless communication can be possible.

Meanwhile, at step 810 (S810), if it is not the first mode, the cradle 200 detects whether the second mode is set by the switch BOT (S812), and if applicable, deactivates the wired connection mode (S814).

For example, when the first mode which is a wired connection mode is switched to the second mode which is a wireless connection mode, the interface 230 can stop audio signal exchange with the electronic device (600 or 600b) connected to the input terminal TE by wire or can stop audio signal reception.

Meanwhile, at step 820 (S820), when the first cable CABa is not connected to the input terminal TE, the external device interface 230 in the cradle 200 detects whether the second cable CABb is connected to the input terminal TE (S830), and if applicable, performs unidirectional wired audio reception with the connected electronic device (600 or 600b) through the second cable CABb, and the transceiver 235 in the cradle 200 performs unidirectional wireless audio transmission with the wireless audio device 100a1, 100a2 (S835).

For example, in a wired connection mode, when the second cable CABb is connected to the input terminal TE, the transceiver 235, the interface 230, receives a third audio signal Sgc from the electronic device (600 or 600b), and the transceiver 235 can convert the third audio signal Sgc, and wirelessly transmit the converted third audio signal Sgc to the wireless audio device 100a1, 100a2.

As another example, in the wired connection mode, when the second cable CABb is connected to the input terminal TE, the transceiver 235 receives a fourth audio signal Sgd from the wireless audio device 100a1, 100a2 wirelessly, and the interface 230 need not transmit the converted fourth audio signal Sgd to the electronic device (600 or 600b) that is wire-connected to the input terminal TE.

As another example, in the wired connection mode, when the second cable CABb is connected to the input terminal TE, the transceiver 235 need not receive the audio signal from the wireless audio device 100a1, 100a2 wirelessly.

Meanwhile, after step 835 (S835), the external device interface 230 in the cradle 200 detects whether the connection of the second cable CABb connected to the input terminal TE is disconnected, in the wired connection mode, and if applicable, can stop unidirectional wired audio reception with the electronic device (600 or 600b) through the second cable CABb.

Meanwhile, in the wired connection mode, when the connection of the second cable CABb connected to the input terminal TE is disconnected, the transceiver 235 can attempt a wireless connection with the electronic device (600 or 600b) connected to the input terminal TE by wire. Accordingly, seamless audio replay is possible.

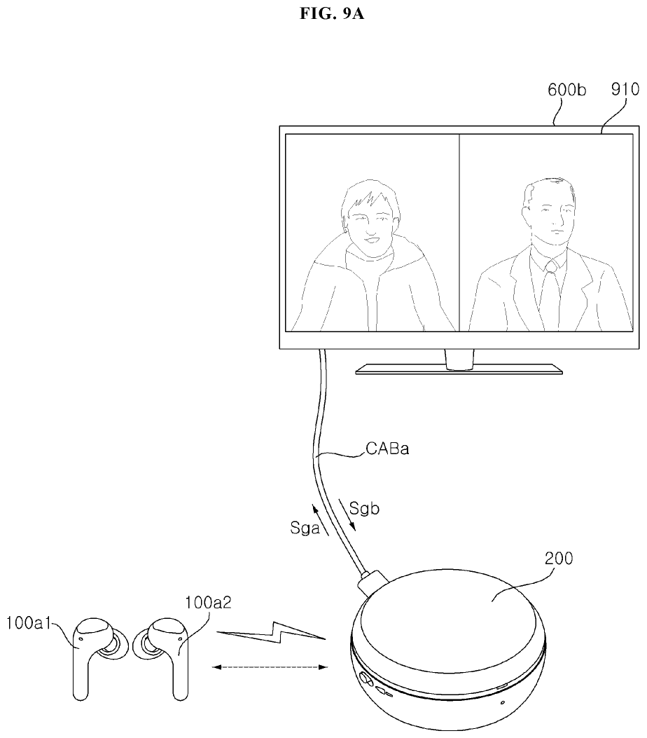

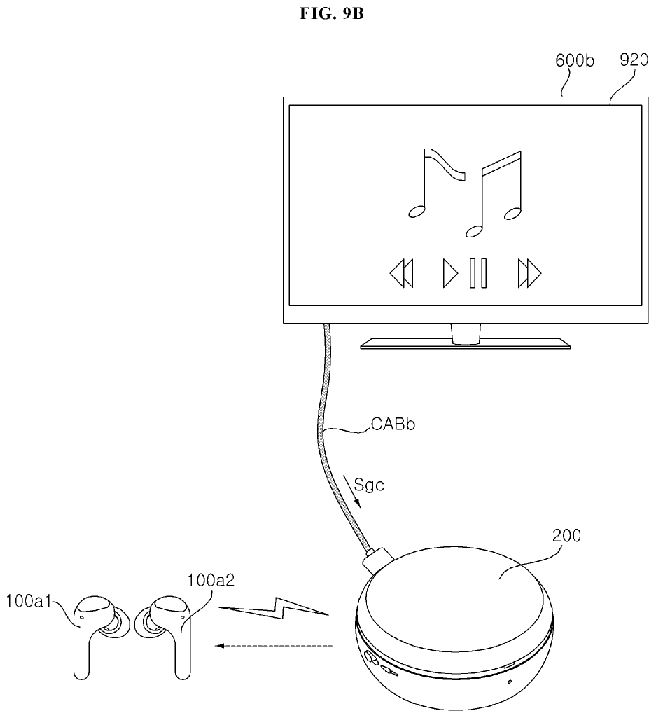

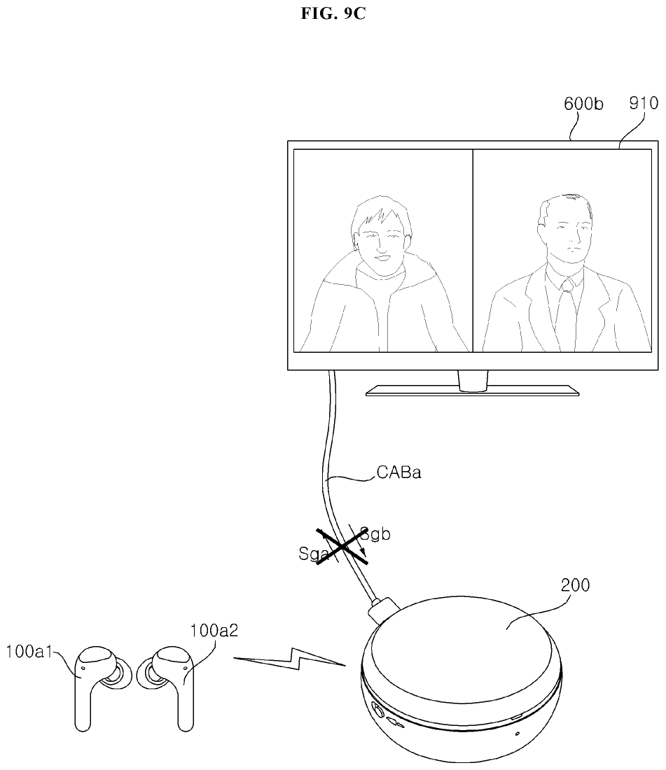

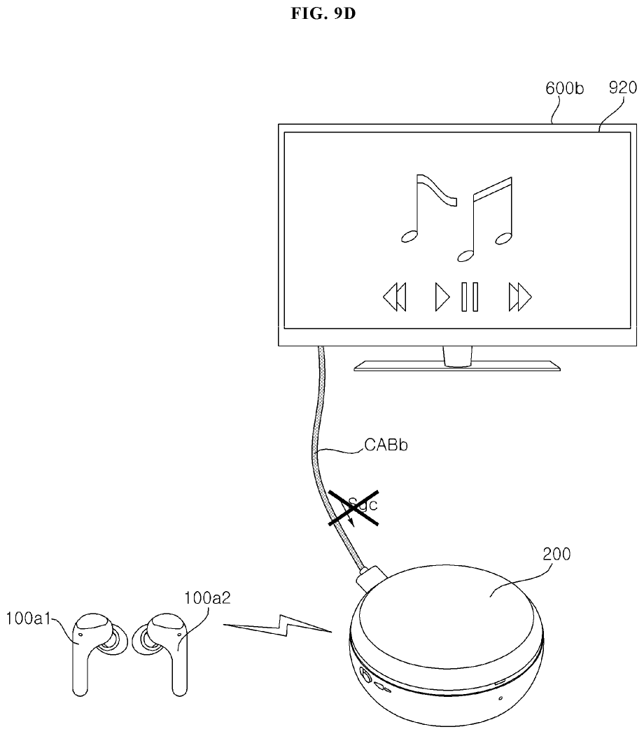

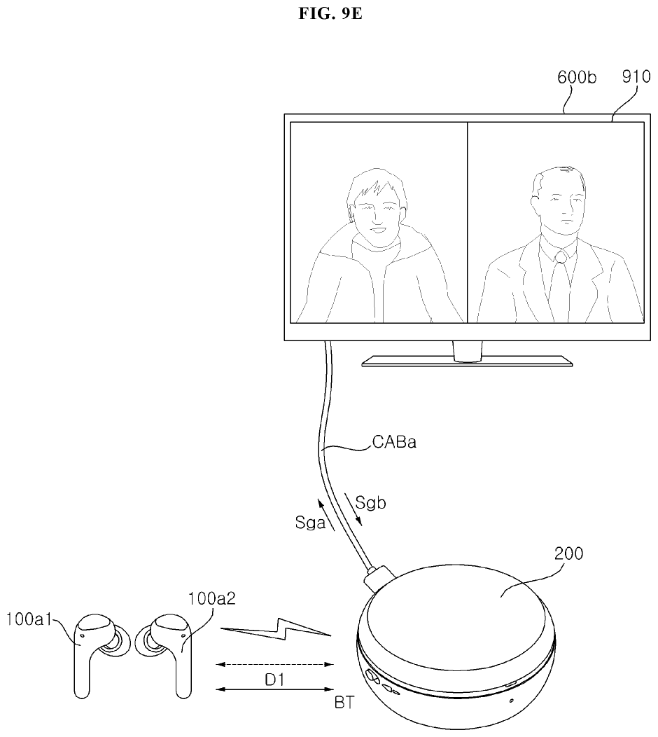

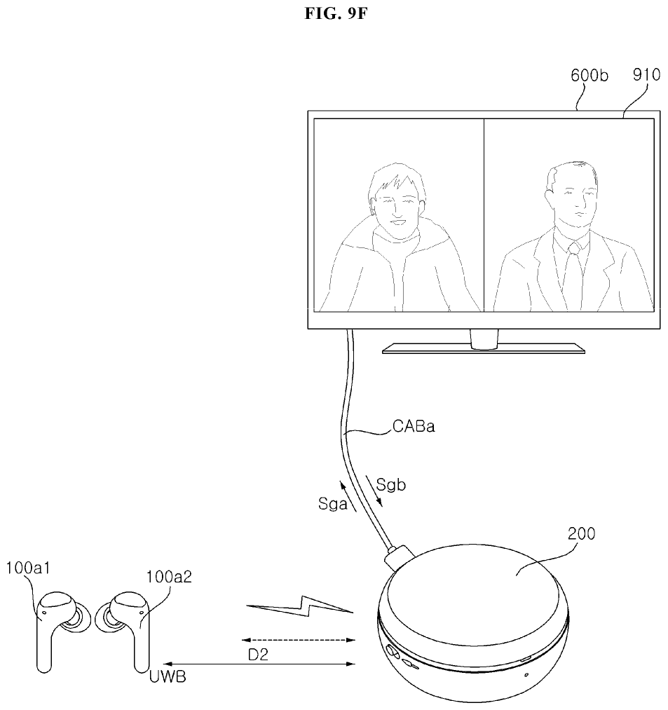

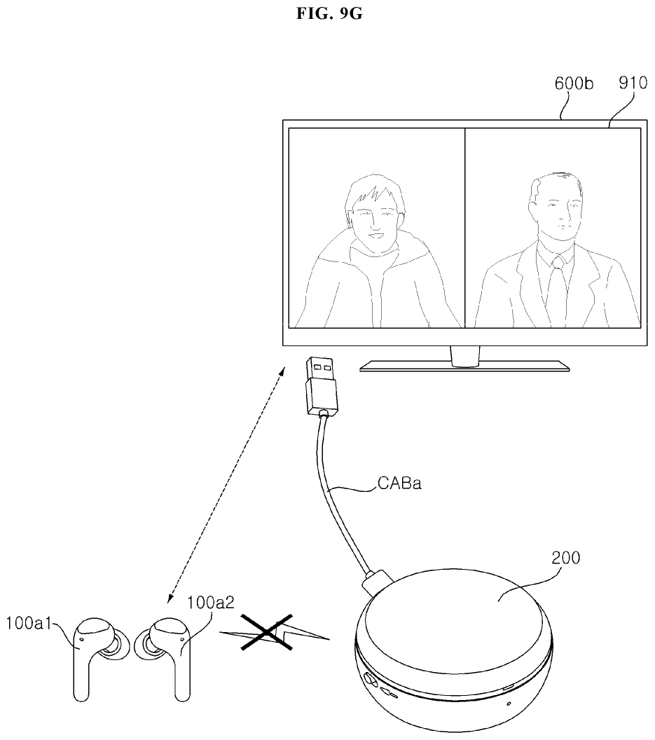

FIGS. 9A to 12C are diagrams for explaining FIG. 9.

FIG. 9A is a diagram illustrating a case in which a first cable CABa is connected to an input terminal TE in a wired connection mode.

Referring to FIG. 9A, in the wired connection mode, when the first cable CABa is connected to the input terminal TE, the transceiver 235 can activate an Advanced Audio Distribution Profile (A2DP) protocol, and make a call profile (HFP) protocol to be ready.

Meanwhile, as shown, when a video chatting screen or video phone screen 910 is displayed on the electronic device 600b connected through the first cable CABa, the transceiver 235 can receive a call profile (HFP) activation signal from the electronic device 600b.

Accordingly, the transceiver 235 can be switched from an Advanced Audio Distribution Profile (A2DP) protocol to a Call Profile (HFP) protocol, activates the Call Profile (HFP) protocol, open a Synchronous Connection Oriented Link (SCo link), and through a corresponding link, perform a bi-directional wireless audio transmission through a bi-directional link.

For example, as shown, the transceiver 235 wirelessly receives the first audio signal Sga from the wireless audio device 100a1, 100a2, and the interface 230 converts the first audio signal Sga received from the transceiver 235, and transmits the converted first audio signal Sga to an electronic device (600 or 600b) wire-connected to the input terminal TE. In addition, the interface 230 receives the second audio signal Sgb from the electronic device (600 or 600b), and the transceiver 235 can convert the second audio signal Sgb, and wirelessly transmit the converted second audio signal Sgb to the wireless audio device 100a1, 100a2.

Accordingly, bi-directional wireless audio transmission can be performed in a wired connection mode. In particular, it is possible to perform a wireless conversation mode through the cradle 200.

FIG. 9B is a diagram illustrating a case in which the second cable CABb is connected to the input terminal TE, in a wired connection mode.

Referring to FIG. 9B, when the second cable CABb is connected to the input terminal TE, in the wired connection mode, the transceiver 235 sets only the Advanced Audio Distribution Profile (A2DP) profile, and need not perform settings for the call profile (HFP).

Meanwhile, as shown, when a music play screen 920 is displayed on the electronic device 600b connected through the second cable CABb, the interface 230 can receive a third audio signal Sgc from the electronic device (600 or 600b), and the transceiver 235 can convert the third audio signal Sgc and wirelessly transmit the converted third audio signal Sgc to the wireless audio device 100al, 100a2. Accordingly, unidirectional wireless audio transmission can be performed in a wired connection mode.

Meanwhile, in the wired connection mode, when the second cable CABb is connected to the input terminal TE, the transceiver 235 can wirelessly transmit a fourth audio signal Sgd from the wireless audio device 100a1, 100a2, and the interface 230 need not transmit the converted fourth audio signal Sgd to the electronic device (600 or 600b) wire-connected to the input terminal TE. Accordingly, bi-directional wireless audio transmission need not be performed in the wired connection mode, and unidirectional wireless audio transmission can be performed.

Meanwhile, in the wired connection mode, when the second cable CABb is connected to the input terminal TE, the transceiver 235 need not wirelessly receive an audio signal from the wireless audio device 100a1, 100a2. Accordingly, bi-directional wireless audio transmission need not be performed in the wired connection mode, and unidirectional wireless audio transmission can be performed.

FIG. 9B is a diagram illustrating a case in which the first cable CABa is connected to the input terminal TE in the wireless connection mode.

Referring to FIG. 9B, unlike FIG. 9A, when a button in the switch BOT moves to the right, the wired connection mode is canceled and the wireless connection mode can be set.

Accordingly, in the wireless connection mode, the interface 230 can stop the bi-directional wired audio transmission with the wire-connected electronic device (600 or 600b).

Meanwhile, in the wireless connection mode, the transceiver 235 can maintain a wireless connection with the wireless audio device 100a1, 100a2.

Alternatively, unlike the drawing, in the wireless connection mode, the transceiver 235 can also stop the wireless connection with the wireless audio device 100a1, 100a2.

Meanwhile, referring to FIGS. 9A and 9B, in the wired connection mode, when the first cable CABa is connected to the input terminal TE, the transceiver 235 in the cradle 200 according to an embodiment of the present disclosure performs the bi-directional wireless audio transmission for audio signal exchange with the wireless audio device 100a1, 100a2. In addition, in the wired connection mode, when the second cable CABb is connected to the input terminal TE, the transceiver 235 can perform the unidirectional wireless audio transmission for audio transmission to the wireless audio device 100a1, 100a2.

Accordingly, the bi-directional or unidirectional wireless audio transmission can be performed according to the type of connected cable in the wired connection mode.

FIG. 9C is a diagram illustrating a case in which the second cable CABb is connected to the input terminal TE in the wireless connection mode.

Referring to FIG. 9C, unlike FIG. 9B, when the button in the switch BOT moves to the right, the wired connection mode is canceled and the wireless connection mode can be set.

Accordingly, in the wireless connection mode, the interface 230 can stop the unidirectional wired audio reception from the wire-connected electronic device (600 or 600b).

Meanwhile, in the wireless connection mode, the transceiver 235 can maintain a wireless connection with the wireless audio device 100a1, 100a2.

Alternatively, unlike the drawing, in the wireless connection mode, the transceiver 235 can also stop the wireless connection with the wireless audio device 100a1, 100a2.

FIG. 9E illustrates that the distance between the cradle and the wireless audio device 100a1, 100a2 is a first distance D1.

Referring to FIG. 9E, when the first cable CABa is connected to the input terminal TE in the wired connection mode, the transceiver 235 can perform bi-directional wireless audio transmission BT with the wireless audio device 100a1, 100a2 through the first communication module 235a, and perform bi-directional wired audio transmission with the electronic device 600b through the interface 230.

Meanwhile, referring to FIGS. 9A to 9D, in response to the first mode being set through the switch BOT, the cradle 200 according to the embodiment of the present disclosure activates a wired connection mode with the electronic device (600 or 600b) connected to the input terminal TE, and activates a wireless connection mode with the wireless audio device 100a1, 100a2, and when the second mode is set through the switch BOT, deactivates the wired connection mode, and activates a wireless connection mode with the wireless audio device 100a1, 100a2.

Accordingly, the bidirectional or unidirectional wireless audio transmission can be performed through a wired connection mode. Meanwhile, through the wired connection mode, it is possible to increase an audio transmittable distance between the electronic device (600 or 600b) and the wireless audio device 100a1, 100a2.

FIG. 9F illustrates that the distance between the cradle and the wireless audio device 100a1, 100a2 is a second distance D2 greater than the first distance D1.

Referring to FIG. 9F, when the first cable CABa is connected to the input terminal TE in the wired connection mode, the transceiver 235 performs bi-directional wireless audio transmission UWB with the wireless audio output device 100a1, 100a2 through the second communication module 235b, and performs bi-directional wired audio transmission with the electronic device 600b, through the interface 230.

For example, when a user wearing the wireless audio device 100al, 100a2 moves from FIG. 9E to FIG. 9F, the packet error rate of the audio signal exchanged or transmitted in the first communication module 235a can be higher than a certain value. Accordingly, the cradle 200 can be switched from the first communication module 235a to the second communication module 235b to perform the directional wireless audio transmission.

Accordingly, it is possible to stably perform wireless audio transmission even when the wireless environment is complicated. In addition, a stable wireless connection distance between the wireless audio device 100a1, 100a2 and the cradle 200 can be secured.

FIG. 9F illustrates disconnection of the first cable CABa connected to the input terminal TE in the wired connection mode.

Referring to FIG. 9F, in the wired connection mode, when the connection of the first cable CABa connected to the input terminal TE is disconnected, the transceiver 235 can attempt a wireless connection with the electronic device 600b connected to the input terminal TE by wire.

For example, the transceiver 235 can transmit a pairing signal for wireless connection or receive a pairing signal, by using wireless network information of the electronic device 600b.

Based on this, the transceiver 235 can perform a wireless connection to the electronic device 600b which canceled the wired connection, thereby maintaining bi-directional wireless audio transmission.

Meanwhile, similar to FIG. 9F, in the wired connection mode, when the connection of the second cable CABb connected to the input terminal TE is disconnected, the transceiver 235 can attempt a wireless connection with the electronic device 600b connected to the input terminal TE by wire.

For example, the transceiver 235 can transmit a pairing signal for wireless connection or receive a pairing signal, by using wireless network information of the electronic device 600b.

Based on this, the transceiver 235 performs a wireless connection to the electronic device 600b which canceled the wired connection, so that unidirectional wireless audio reception can be maintained.

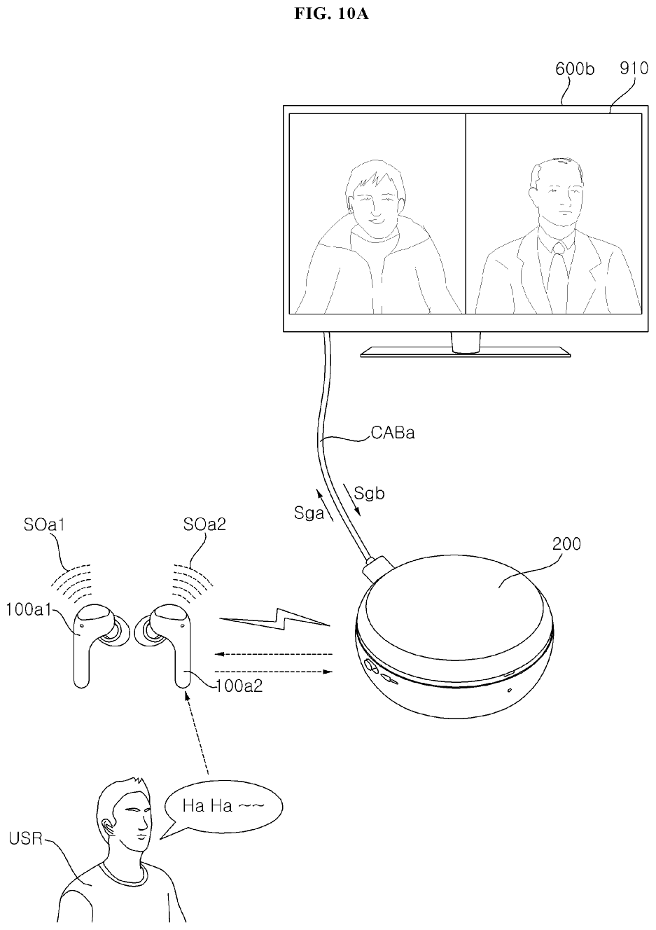

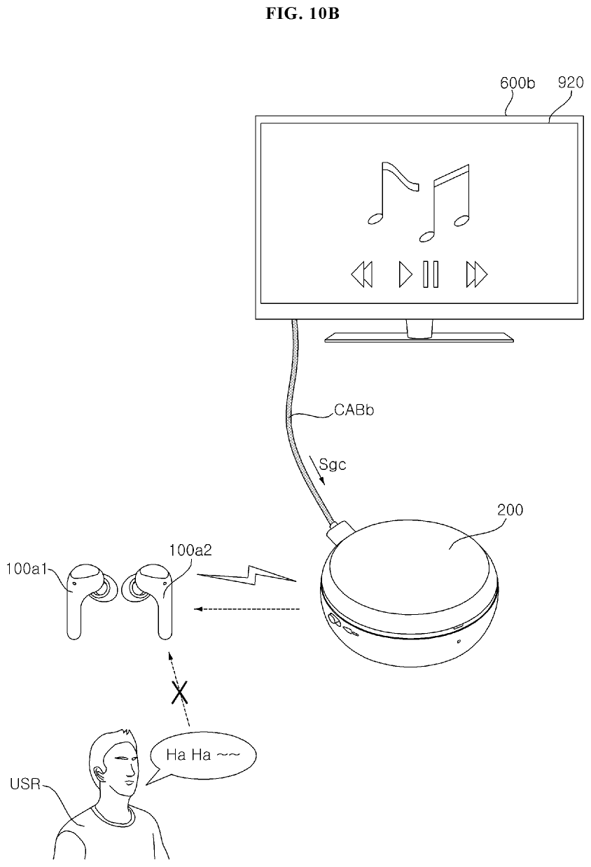

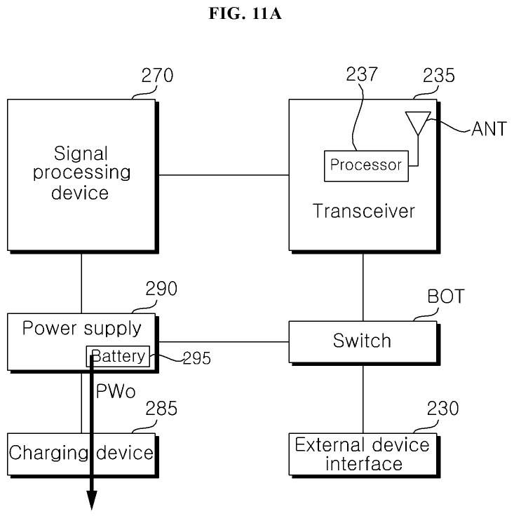

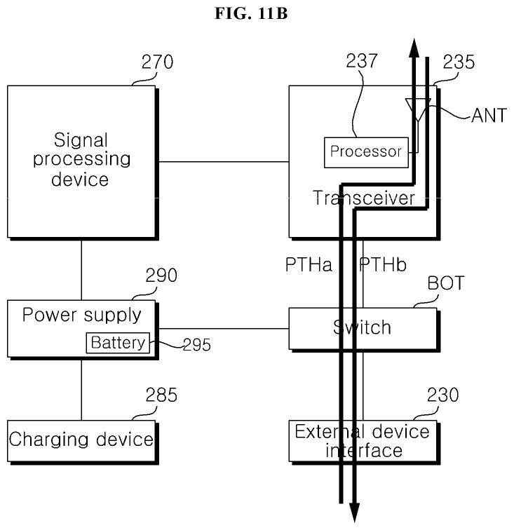

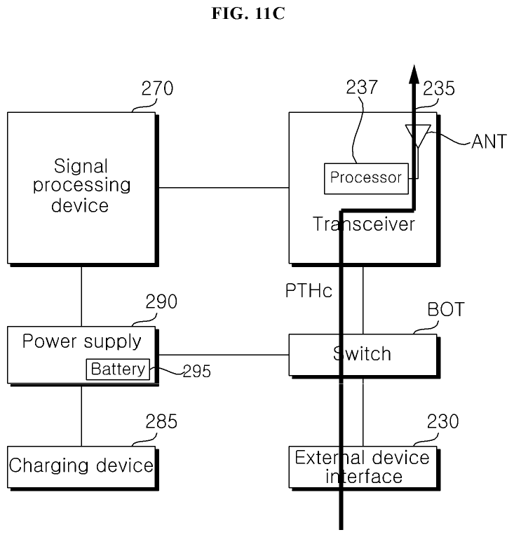

FIG. 10A illustrates that the first cable CABa connected to the input terminal TE is connected in the wired connection mode corresponding to FIG. 9A.

Referring to FIG. 10A, when a user USR speaks, the microphone 187 in the wireless audio device 100a1, 100a2 converts a sound into a first audio signal.

Meanwhile, the transceiver 235 in the cradle wirelessly receives the first audio signal Sga from the wireless audio device 100a1, 100a2 through a call profile (HFP) protocol, and the interface 230 converts the first audio signal Sga received from the transceiver 235, and transmits the converted first audio signal Sga to the electronic device (600 or 600b) wire-connected to the input terminal TE.

Meanwhile, the interface 230 receives the second audio signal Sgb from the electronic device (600 or 600b), and the transceiver 235 converts the second audio signal Sgb and wirelessly transmits the converted second audio signal Sgb to the wireless audio device 100a1, 100a2. Accordingly, a wireless conversation mode using the cradle 200 can be supported.

FIG. 10B illustrates that the second cable CABb connected to the input terminal TE is connected in the wired connection mode corresponding to FIG. 9B.

Referring to FIG. 10B, when a user USR speaks, the microphone 187 in the wireless audio device 100al, 100a2 converts a sound into the first audio signal.

Meanwhile, since the call profile (HFP) protocol is deactivated, the transceiver 235 in the cradle cannot wirelessly receive the first audio signal Sga from the wireless audio device 100a1, 100a2.

As a result, the interface 230 receives a third audio signal Sgc from the electronic device (600 or 600b), the transceiver 235 converts the third audio signal Sgc and, through the Advanced Audio Distribution Profile (A2DP) protocol, can wirelessly transmit the converted third audio signal Sgc to the wireless audio device 100a1, 100a2. Accordingly, unidirectional wireless audio transmission can be performed in the wired connection mode.

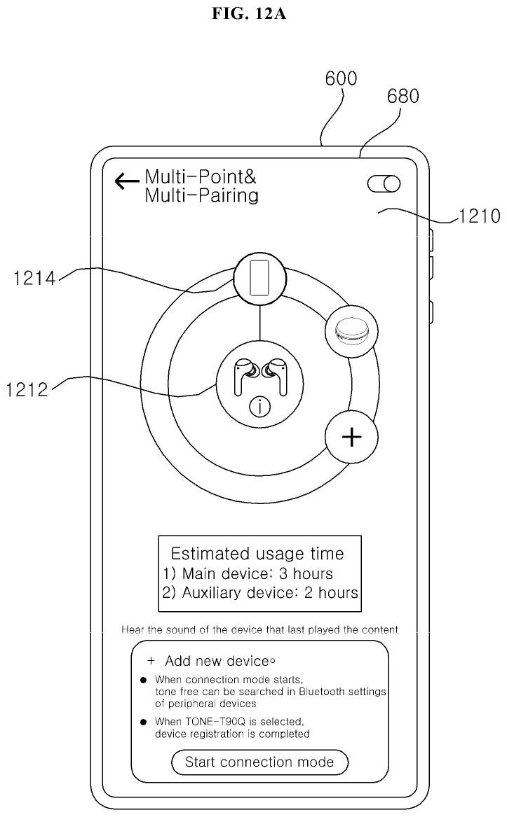

FIG. 11A is another example of an internal block diagram of a cradle according to an embodiment of the present disclosure.

Referring to FIG. 11A, the cradle 200 according to an embodiment of the present disclosure can supply a DC voltage from the battery 295 in the power supply 290 by a current path PWo toward the charging device 285.

FIG. 11B is a diagram illustrating a signal path when the first cable CABa is connected to the input terminal TE in the wired connection mode.

Referring to FIG. 11B, the first audio signal Sga received from the wireless audio device 100a1, 100a2 is received through the antenna ANT in the transceiver 235, and converted in the processor 237.

The converted first audio signal Sga can be transmitted to the connected electronic device (600 or 600b) via the switch BOT and the external device interface 230.

In this case, the converted first audio signal Sga can be directly transmitted to the connected electronic device (600 or 600b) through the external device interface 230 without passing through the switch BOT.

For example, the first audio signal Sga can be transmitted to the connected electronic device (600 or 600b) along a signal path such as PTHb.

Meanwhile, the second audio signal Sgb received from the electronic device (600 or 600b) can be transmitted to the wireless audio device 100a1, 100a2 via the external device interface 230, the switch BOT, and the transceiver 235, along the signal path such as PTHa.

Meanwhile, the second audio signal Sgb can be transmitted from the external device interface 230 to the transceiver 235 without passing through the switch BOT.

At this time, the processor 237 in the transceiver 235 can convert the second audio signal Sgb, and wirelessly transmit the converted second audio signal Sgb to the wireless audio device 100a1, 100a2 through the antenna ANT.

FIG. 11C is a diagram illustrating a signal path when the second cable CABb is connected to the input terminal TE in a wired connection mode.

Referring to FIG. 11C, the third audio signal Sgc received from the electronic device (600 or 600b) can be transmitted to the wireless audio device 100a1, 100a2 via the external device interface 230, the switch BOT, and the transceiver 235, along a signal path such as PTHc.

Meanwhile, the third audio signal Sgc can be transmitted from the external device interface 230 to the transceiver 235 without passing through the switch BOT.

At this time, the processor 237 in the transceiver 235 converts the third audio signal Sgc, and wirelessly transmits the converted third audio signal Sgc to the wireless audio device 100a1, 100a2 through the antenna ANT.

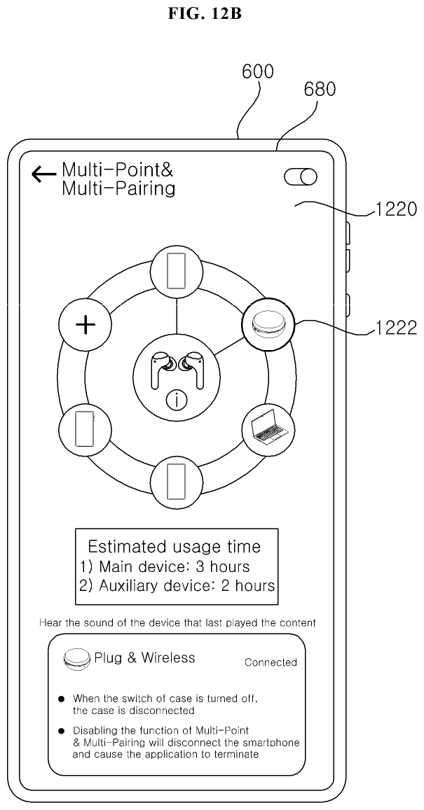

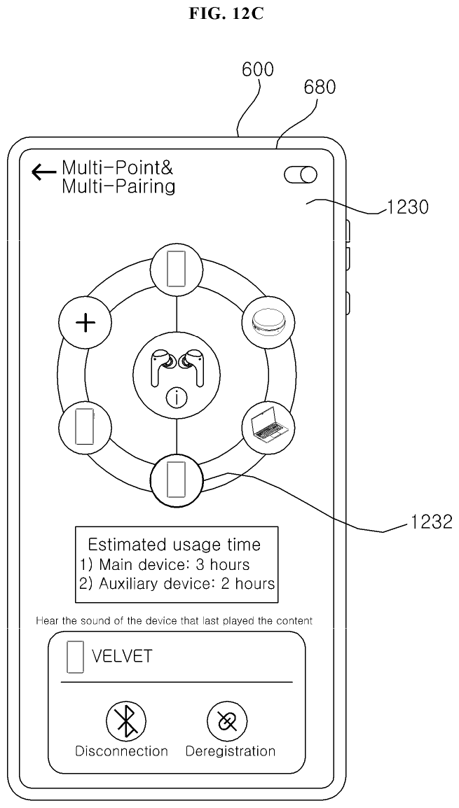

FIGS. 12A to 12C are diagrams illustrating adding a new device, multi-pairing, etc. in a mobile terminal 600, which is an example of an electronic device.

Referring to FIG. 12A, the display 680 of the mobile terminal 600 can display a new device addition screen 1210 for wireless connection.

The new device addition screen 1210 can include a connection mode start item.

FIG. 12A illustrates that the wireless audio device 100a1, 100a2 is added as a device for wireless connection.

For example, FIG. 12A illustrates that an icon 1212 representing the wireless audio device 100a1, 100a2 and an icon 1214 representing the mobile terminal 600 are connected to each other.

For example, the wireless audio device 100a1, 100a2 and the mobile terminal 600 can maintain a paired state.

FIG. 12B illustrates that the cradle 200 is multi-paired. The display 680 of the mobile terminal 600 can display a new device addition screen 1220 for wireless connection.

Referring to FIG. 12B, an icon 1222 representing the cradle 200 can be further connected to an icon 1212 representing the wireless audio device 100a1, 100a2.

For example, the wireless audio device 100a1, 100a2 can be additionally paired with the cradle 200 while being paired with the mobile terminal 600.

For example, the wireless audio device 100a1, 100a2 can be multi-paired.

FIG. 12C illustrates multi-pairing with a second mobile terminal. The display 680 of the mobile terminal 600 can display a new device addition screen 1230 for wireless connection.

Referring to FIG. 12C, an icon 1232 representing a second mobile terminal can be further connected to the icon 1212 representing the wireless audio device 100al, 100a2.

For example, the wireless audio device 100a1, 100a2 can be additionally paired with the second mobile terminal while being paired with the mobile terminal 600.

Meanwhile, the wireless audio device 100a1, 100a2 can wirelessly transmit remaining amount information of the battery 295 to the mobile terminal 600 that is a paired electronic device.

Meanwhile, the cradle 200 can wirelessly transmit remaining amount information of the battery 195 to the mobile terminal 600 that is a paired electronic device.

Accordingly, as shown in FIGS. 12A to 12C, available time information (e.g. 3 hours) of the cradle 200 which is a main device, and available time information (e.g. 2 hours) of the wireless audio devices 100a1, 100a2 which is an auxiliary device can be displayed on the display 680 of the mobile terminal 600.

As described above, a cradle and a wireless audio system having the same according to an embodiment of the present disclosure include: a casing including a seating groove for seating a wireless audio device, wherein the casing is at least partially opened and closed; a transceiver disposed in the casing; a switch formed in a part of the casing; and an interface including an input terminal formed in another part of the casing, wherein in response to a first cable being connected to the input terminal in a wired connection mode, the transceiver performs bi-directional wireless audio transmission for audio signal exchange with the wireless audio device, and wherein in response to a second cable being connected to the input terminal in the wired connection mode, the transceiver performs unidirectional wireless audio transmission for audio transmission to the wireless audio device. Accordingly, bidirectional or unidirectional wireless audio transmission can be performed through a wired connection mode. In particular, bidirectional or unidirectional wireless audio transmission can be performed according to the type of connected cable in the wired connection mode. Meanwhile, through the wired connection mode, it is possible to increase an audio transmittable distance between an electronic device and a wireless audio device.

Meanwhile, in response to the first cable being connected to the input terminal in the wired connection mode, the interface performs bi-directional wired audio transmission for exchanging audio signals with an electronic device connected to the input terminal by wire, and in response to a second cable being connected to the input terminal in the wired connection mode, performs unidirectional wired audio reception for receiving an audio signal from an electronic device connected to the input terminal by wire. Accordingly, bidirectional or unidirectional wireless audio transmission can be performed according to the type of connected cable in the wired connection mode.

Meanwhile, in response to a first mode being set through the switch, the wired connection mode is activated, and in response to a second mode being set through the switch, the wired connection mode is deactivated. Accordingly, bidirectional or unidirectional wireless audio transmission can be performed according to the type of connected cable in the wired connection mode.

Meanwhile, in response to the first mode being switched to the second mode, the interface stops an audio signal exchange with an electronic device connected to the input terminal by wire, or stops an audio signal reception. Accordingly, the wired connection mode is stopped.

Meanwhile, in response to the first cable being connected to the input terminal in the wired connection mode, the transceiver wirelessly receives a first audio signal from the wireless audio device, and the interface converts the first audio signal received from the transceiver and transmits the converted first audio signal to an electronic device connected to the input terminal by wire, and wherein the interface receives a second audio signal from the electronic device, and the transceiver converts the second audio signal and wirelessly transmits the converted second audio signal to the wireless audio device. Accordingly, bidirectional wireless audio transmission can be performed in the wired connection mode. In particular, the wireless conversation mode can be supported in the wired connection mode.

Meanwhile, in response to the second cable being connected to the input terminal in the wired connection mode, the interface receives a third audio signal from the electronic device, wherein the transceiver converts the third audio signal and wirelessly transmits the converted third audio signal to the wireless audio device. Accordingly, unidirectional wireless audio transmission can be performed in the wired connection mode.

Meanwhile, in response to the second cable being connected to the input terminal in the wired connection mode, the transceiver wirelessly receives a fourth audio signal from the wireless audio device, wherein the interface does not transmit a converted fourth audio signal to an electronic device connected to the input terminal by wire. Accordingly, bi-directional wireless audio transmission is not performed in the wired connection mode, and unidirectional wireless audio transmission can be performed.

Meanwhile, in response to the second cable being connected to the input terminal in the wired connection mode, the transceiver does not wirelessly receive an audio signal from the wireless audio device. Accordingly, bi-directional wireless audio transmission is not performed in the wired connection mode, and unidirectional wireless audio transmission can be performed.

Meanwhile, in response to a connection of the first cable connected to the input terminal being disconnected in the wired connection mode, the transceiver attempts a wireless connection with the electronic device connected to the input terminal by wire. Accordingly, it is possible to seamlessly perform wireless communication with the electronic device even after cable connection is disconnected.

Meanwhile, in response to a connection of the second cable connected to the input terminal being disconnected in the wired connection mode, the transceiver attempts a wireless connection with the electronic device connected to the input terminal by wire. Accordingly, it is possible to seamlessly receive a wireless signal from an electronic device even after cable connection is disconnected.

Meanwhile, the transceiver includes: a first communication module configured to wirelessly exchange audio or transmits audio with or to the wireless audio device based on a first communication standard of a first frequency band; and a second communication module configured to wirelessly exchange audio or transmits audio with or to the wireless audio device based on a second communication standard of a second frequency band greater than the first frequency band, and any one of the first communication module and the second communication module performs audio exchange or audio transmission with or to the wireless audio device. Accordingly, it is possible to stably perform wireless audio transmission even when the wireless environment is complicated.

Meanwhile, the transceiver performs audio exchange or audio transmission with or to the wireless audio device during a first period through the first communication module, and in response to a packet error rate of the exchanged or transmitted audio signal being greater than or equal to a certain value during the first period, performs audio exchange or audio transmission with or to the wireless audio device through the second communication module, during a second period after the first period. Accordingly, audio service switching can be performed seamlessly through the first communication module and the second communication module of different communication standards.

Meanwhile, the first communication module transmits a message for switching to the second communication standard to the wireless audio device, in response to the packet error rate of the audio signal exchanged in or transmitted from the first communication module being greater than or equal to the certain value. Accordingly, audio service switching can be performed seamlessly through the first communication module and the second communication module of different communication standards.

A cradle and a wireless audio system having the same according to another embodiment of the present disclosure include: a casing including a seating groove for seating a wireless audio device, wherein the casing is at least partially opened and closed; a transceiver disposed in the casing; a switch formed in a part of the casing; and an interface including an input terminal formed in another part of the casing, wherein in response to a first mode being set through the switch, a wired connection mode with an electronic device connected to the input terminal is activated, and a wireless connection mode with the wireless audio device is activated, and in response to a second mode being set through the switch, the wired connection mode is deactivated and the wireless connection mode with the wireless audio device is activated. Accordingly, bidirectional or unidirectional wireless audio transmission can be performed through a wired connection mode. Meanwhile, through the wired connection mode, it is possible to increase an audio transmittable distance between an electronic device and a wireless audio device.

Meanwhile, in response to the first cable being connected to the input terminal in the wired connection mode, the transceiver performs bi-directional wireless audio transmission for audio signal exchange with the wireless audio device, and wherein in response to a second cable being connected to the input terminal in the wired connection mode, the transceiver performs unidirectional wireless audio transmission for audio transmission to the wireless audio device. Accordingly, bidirectional or unidirectional wireless audio transmission can be performed according to the type of connected cable in the wired connection mode.

A wireless audio system according to an embodiment of the present disclosure includes: a wireless audio device and a cradle. Accordingly, bidirectional or unidirectional wireless audio transmission can be performed through a wired connection mode. In particular, bidirectional or unidirectional wireless audio transmission can be performed according to the type of connected cable in the wired connection mode.

Although the preferred embodiments of the present disclosure have been shown and described above, the present disclosure is not limited to the specific embodiments described above, and is common in the art to which the present disclosure pertains without departing from the gist of the present disclosure claimed in the claims. Of course, various modifications and implementations are possible by those with knowledge of, and these modifications should not be individually understood from the technical spirit or perspective of the present disclosure.

What is claimed is:

1. A cradle for a wireless audio device, the cradle comprising:
a casing including a seating groove for seating the wireless audio device, wherein the casing is able to be opened and closed;
a transceiver disposed in the casing;
a switch formed in a part of the casing; and
an external device interface including an input terminal formed in another part of the casing,
wherein in response to a first cable being connected to the input terminal in a wired connection mode, one of the transceiver and the external device interface performs a bi-directional wireless audio transmission for audio signal exchange with the wireless audio device, and
wherein in response to a second cable being connected to the input terminal in the wired connection mode, one of the transceiver and the external device interface performs a unidirectional wireless audio transmission for audio transmission to the wireless audio device.

2. The cradle of claim 1, wherein in response to a first mode being set through the switch, the wired connection mode is activated, and
wherein in response to a second mode being set through the switch, the wired connection mode is deactivated.

3. The cradle of claim 2, wherein in response to the first mode being switched to the second mode, the external device interface stops an audio signal exchange with an electronic device connected to the input terminal by the first cable or the second cable, or stops an audio signal reception.

4. The cradle of claim 1, wherein in response to the first cable being connected to the input terminal in the wired connection mode, the transceiver wirelessly receives a first audio signal from the wireless audio device, and the external device interface converts the first audio signal received from the transceiver and transmits the converted first audio signal to an electronic device connected to the input terminal by the first cable, and
wherein the external device interface receives a second audio signal from the electronic device, and the transceiver converts the second audio signal and wirelessly transmits the converted second audio signal to the wireless audio device.

5. The cradle of claim 1, wherein in response to the second cable being connected to the input terminal in the wired connection mode, the external device interface receives a third audio signal from the electronic device,
wherein the transceiver converts the third audio signal and wirelessly transmits the converted third audio signal to the wireless audio device.

6. The cradle of claim 5, wherein in response to the second cable being connected to the input terminal in the wired connection mode, the transceiver wirelessly receives a fourth audio signal from the wireless audio device,
wherein the external device interface does not transmit a converted fourth audio signal to an electronic device connected to the input terminal by the second cable.

7. The cradle of claim 5, wherein in response to the second cable being connected to the input terminal in the wired connection mode, the transceiver does not wirelessly receive an audio signal from the wireless audio device.

8. The cradle of claim 1, wherein in response to a connection of the first cable connected to the input terminal being disconnected in the wired connection mode, the transceiver attempts a wireless connection with the electronic device previously connected to the input terminal by the first cable.

9. The cradle of claim 1, wherein in response to a connection of the second cable connected to the input terminal being disconnected in the wired connection mode, the transceiver attempts a wireless connection with the electronic device previously connected to the input terminal by the second cable.

10. The cradle of claim 1, wherein the transceiver comprises:
a first communication module configured to wirelessly exchange audio or transmits audio with or to the wireless audio device based on a first communication standard of a first frequency band; and
a second communication module configured to wirelessly exchange audio or transmits audio with or to the wireless audio device based on a second communication standard of a second frequency band greater than the first frequency band, and
wherein any one of the first communication module and the second communication module performs audio exchange or audio transmission with or to the wireless audio device.

11. The cradle of claim 10, wherein the transceiver performs the audio exchange or the audio transmission with or to the wireless audio device during a first period through the first communication module, and
wherein in response to a packet error rate of the exchanged or transmitted audio signal being greater than or equal to a certain value during the first period, performs the audio exchange or the audio transmission with or to the wireless audio device through the second communication module, during a second period after the first period.

12. The cradle of claim 11, wherein the first communication module transmits a message for switching to the second communication standard to the wireless audio device, in response to the packet error rate of the audio signal exchanged in or transmitted from the first communication module being greater than or equal to the certain value.

13. A cradle for a wireless audio device, the cradle comprising:
a casing including a seating groove for seating the wireless audio device, wherein the casing is able to be opened and closed;
a transceiver disposed in the casing;
a switch formed in a part of the casing; and
an external device interface including an input terminal formed in another part of the casing,
wherein in response to a first mode being set through the switch, a wired connection mode with an electronic device connected to the input terminal is activated, and a wireless connection mode with the wireless audio device is activated, and
wherein in response to a second mode being set through the switch, the wired connection mode is deactivated and the wireless connection mode with the wireless audio device is activated.

14. The cradle of claim 13, wherein in response to a first cable being connected to the input terminal in the wired connection mode, one of the transceiver and the external device interface performs a bi-directional wireless audio transmission for audio signal exchange with the wireless audio device, and
wherein in response to a second cable being connected to the input terminal in the wired connection mode, one of the transceiver and the external device interface performs a unidirectional wireless audio transmission for audio transmission to the wireless audio device.

15. A wireless audio system comprising:
a wireless audio device; and
a cradle for the wireless audio device,
wherein the cradle comprises:
a casing including a seating groove for seating the wireless audio device, the casing being able to be opened and closed;
a transceiver disposed in the casing;
a switch formed in a part of the casing; and
an external device interface including an input terminal formed in another part of the casing,
wherein in response to a first cable being connected to the input terminal in a wired connection mode, one of the transceiver and the external device interface performs a bi-directional wireless audio transmission for audio signal exchange with the wireless audio device, and
wherein in response to a second cable being connected to the input terminal in the wired connection mode, one of the transceiver and the external device interface performs a unidirectional wireless audio transmission for audio transmission to the wireless audio device.

16. The wireless audio system of claim 15, wherein in response to the first cable being connected to the input terminal in the wired connection mode, the external device interface performs the bi-directional wired audio transmission for exchanging audio signals with an electronic device connected to the input terminal by the first cable, and
wherein in response to the second cable being connected to the input terminal in the wired connection mode, the external device interface performs a unidirectional wired audio reception for receiving an audio signal from the electronic device connected to the input terminal by the second cable.

17. The wireless audio system of claim 15, wherein in response to a first mode being set through the switch, the wired connection mode is activated, and
wherein in response to a second mode being set through the switch, the wired connection mode is deactivated.

18. The wireless audio system of claim 15, wherein in response to the first cable being connected to the input terminal in the wired connection mode, the transceiver wirelessly receives a first audio signal from the wireless audio device, and the external device interface converts the first audio signal received from the transceiver and transmits the converted first audio signal to the electronic device connected to the input terminal by the first cable, and
wherein the external device interface receives a second audio signal from the electronic device, and the transceiver converts the second audio signal and wirelessly transmits the converted second audio signal to the wireless audio device.

19. The wireless audio system of claim 15, wherein in response to the second cable being connected to the input terminal in the wired connection mode, the external device interface receives a third audio signal from the electronic device,
wherein the transceiver converts the third audio signal and wirelessly transmits the converted third audio signal to the wireless audio device.

20. The wireless audio system of claim 15, wherein the wireless audio device is at least one earbud.
